(19) United States
(12) Patent Application Publication
(10) Pub. No.: US 2025/0070651 A1
(43) Pub. Date: Feb. 27, 2025

(54) TOTEM POLE POWER FACTOR CORRECTION CIRCUIT WITH REVERSE CURRENT LIMIT AND CONTROL METHOD THEREOF

(71) Applicant: Chengdu Monolithic Power Systems Co., Ltd., Chengdu (CN)

(72) Inventors: Guangzhuo Li, Hangzhou (CN); Pengfei Liu, Hangzhou (CN)

(21) Appl. No.: 18/743,856

(22) Filed: Jun. 14, 2024

(30) Foreign Application Priority Data
Aug. 23, 2023 (CN) 202311069345.8

(51) Int. Cl. H02M 1/42

(52) U.S. Cl. CPC H02M 1/4233

(57) ABSTRACT

A control circuit for a totem pole PFC circuit with a low side power switch coupled between a switching node and a reference ground. The control circuit includes fourth pins. The first pin is coupled to the switching node. The second pin is coupled to the switching node through a first unidirectional device. The third pin is coupled to a control terminal of the low side power switch. The fourth pin is configured to be coupled to the reference ground. The control circuit is configured to control the turning-off of the low side power switch based on a first voltage indicative of a drain-source voltage of the low side power switch.

### CROSS-REFERENCE TO RELATED APPLICATIONS

This application claims the benefit of CN application 202311069345.8, filed on Aug. 23, 2023, and incorporated herein by reference.

### TECHNICAL FIELD OF THE INVENTION

The present invention generally relates to electronic circuits, and more particularly but not exclusively, to totem pole PFC (power factor correction) circuits and associated control methods.

### BACKGROUND OF THE INVENTION

In the power supply field, power factor can be used to measure the circuit efficiency and higher power factor means higher power conversion efficiency. The technology used to improve the power factor of a circuit is called PFC. Prior PFC topologies includes full bridge PFC circuits, half bridge PFC circuits and bridgeless PFC circuits. The totem pole PFC circuit is one of the bridgeless PFC circuits and has been widely used due to its low conduction loss and high circuit efficiency.

### SUMMARY OF THE INVENTION

An embodiment of the present invention discloses a control circuit for a totem pole PFC circuit, where the totem pole PFC circuit has a high side power switch coupled between an output node and a switching node and a low side power switch coupled between the switching node and a reference ground. The control circuit includes a first pin, a second pin, a third pin, a fourth pin, a fifth pin, a switch control circuit, a first comparing circuit and a first logic circuit. The first pin is configured to be coupled to the output node. The second pin is configured to be coupled to a control terminal of the high side power switch. The third pin is configured to be coupled to the switching node. The fourth pin and the fifth pin are configured to be coupled to an AC (alternating current) input voltage The switch control circuit is configured to generate a high side control signal based on the AC input voltage. The first comparing circuit is coupled to the first pin and the third pin and configured to generate a high side off signal by comparing a first voltage indicative of a drain-source voltage of the high side power switch with a first threshold voltage. The first logic circuit is configured to generate a high side drive signal to control the high side power switch based on the high side control signal and the high side off signal.

An embodiment of the present invention discloses a control circuit for a totem pole PFC circuit, where the totem pole PFC circuit has a high side power switch coupled between an output node and a switching node and a low side power switch coupled between the switching node and a reference ground. The control circuit includes a first pin, a second pin, a third pina and a fourth pin. The first pin is configured to be coupled to the switching node. The second pin is configured to be coupled to the switching node through a first unidirectional device. The third pin is configured to be coupled to a control terminal of the low side power switch. The fourth pin is configured to be coupled to the reference ground The control circuit is configured to control the turning-off of the low side power switch based on a first voltage indicative of a drain-source voltage of the low side power switch.

An embodiment of the present invention discloses a totem pole PFC circuit. The totem pole PFC circuit includes an inductor, a first power switch, a second power switch, a high side power switch, a low side power switch, a switch control circuit, a first comparing circuit and a first logic circuit. The inductor is coupled between a first node and a second node. The first power switch is coupled between an output node and the second node. The second power switch is coupled between the second node and a reference ground. The high side power switch is coupled between an output node and a switching node. The low side power switch is coupled between the switching node and a reference ground. The switch control circuit is configured to generate a high side control signal based on an AC input voltage. The first comparing circuit is coupled to the output node and the switching node and configured to generate a high side off signal by comparing a first voltage indicative of a drain-source voltage of the high side power switch with a first threshold voltage. The first logic circuit is configured to generate a high side drive signal to control the high side power switch based on the high side control signal and the high side off signal.

An embodiment of the present invention discloses a control method for a totem pole PFC circuit, where the totem pole PFC circuit has a high side power switch coupled between an output node and a switching node and a low side power switch coupled between the switching node and a reference ground. The control method includes the following steps. 1) Generating a high side control signal based on an AC input voltage. 2) Providing a first conduction path through a first unidirectional device when the AC input voltage is in a negative half cycle. 3) Receiving a first voltage indicative of a drain-source voltage of the high side power switch through the first conduction path. 4) Generating a high side off signal by comparing the first voltage with a first threshold voltage. And 5) generating a high side drive signal to control the high side power switch based on the high side control signal and the high side off signal.

### BRIEF DESCRIPTION OF DRAWINGS

The present invention can be further understood with reference to the following detailed description and the appended drawings, wherein like elements are provided with like reference numerals.

FIG. 1 illustrates a circuit schematic of a totem pole PFC circuit 100.

FIG. 2 illustrates working states of power switches S1˜S4 in the totem pole PFC circuit 100.

FIG. 3 illustrates the flow direction of a reverse current when the AC input voltage Vac changes from positive to negative.

FIG. 4 illustrates a block diagram of a totem pole PFC circuit 200 in accordance with an embodiment of the present invention.

FIG. 5 illustrates working waveforms of the totem pole PFC circuit 200 shown in FIG. 4 in accordance with an embodiment of the present invention.

FIG. 6 illustrates working waveforms of the totem pole PFC circuit 200 shown in FIG. 4 in accordance with another embodiment of the preset invention.

FIG. 7 illustrates a block diagram of a totem pole PFC circuit 200A in accordance with another embodiment of the present invention.

FIG. 8 illustrates a circuit schematic of a totem pole PFC circuit 200B in accordance with an embodiment of the present invention.

FIG. 9 illustrates a circuit schematic of a totem pole PFC circuit 200C in accordance with an embodiment of the present invention.

FIG. 10 illustrates a circuit schematic of a totem pole PFC circuit 200D in accordance with an embodiment of the present invention.

FIG. 11 illustrates a circuit schematic of a totem pole PFC circuit 200E in accordance with an embodiment of the present invention.

FIG. 12 illustrates a circuit schematic of a totem pole PFC circuit 200F in accordance with an embodiment of the present invention.

FIG. 13 illustrates a circuit schematic of a totem pole PFC circuit 200G in accordance with an embodiment of the present invention.

FIG. 14 illustrates a circuit schematic of a totem pole PFC circuit 200H in accordance with an embodiment of the present invention.

FIG. 15 illustrates a flowchart of a control method 1500 used in a totem pole PFC circuit in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

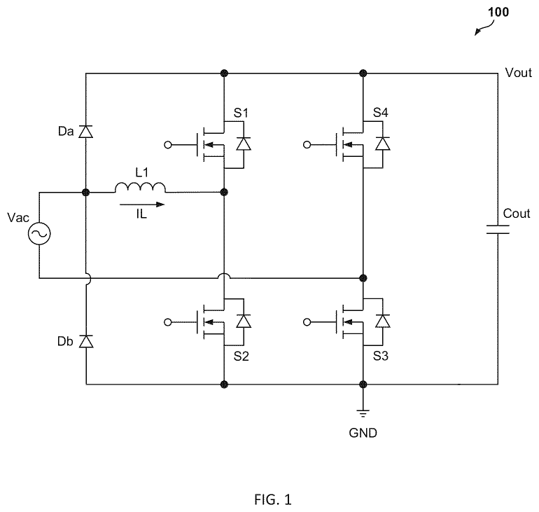

FIG. 1 illustrates a circuit schematic of a totem pole PFC circuit 100. As shown in FIG. 1, the totem pole PFC circuit 100 includes an inductor L1 coupled to an AC (alternating current) input voltage Vac, a first bridge arm having power switches S1 and S2, a second bridge arm having power switches S3 and S4, and an output capacitor Cout. The totem pole PFC circuit 100 converts the AC input voltage Vac into an output voltage Vout via the turning-on and the turning-off of the power switches S1˜S4. As shown in FIG. 1, the totem pole PFC circuit 100 further includes diodes Da and Db coupled to the AC input voltage Vac to speed up the start-up of the totem pole PFC circuit 100.

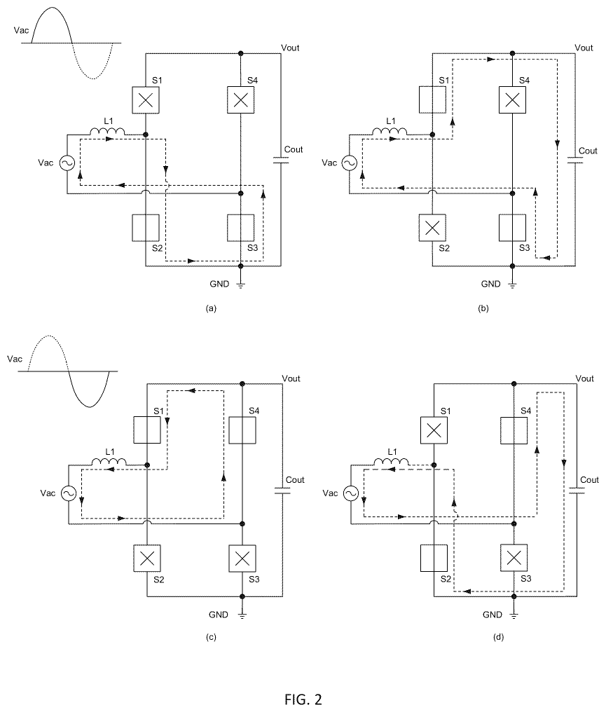

FIG. 2 illustrates working states of the power switches S1˜S4 in the totem pole PFC circuit 100. When the AC input voltage Vac is in a positive half cycle, the power switch S3 keeps ON, the power switch S4 keeps OFF, the power switch S1 and the power switch S2 switch between ON and OFF. The direction of a current of the totem pole PFC circuit 100 is shown as FIG. 2(a) and FIG. 2(b). In FIG. 2(a), the current flows successively through the inductor L1, the power switch S2 and the power switch S3. In FIG. 2(b), the current flows successively through the inductor L1, the power switch S1, the output capacitor Cout and the power switch S3.

When the AC input voltage Vac is in a negative half cycle, the power switch S3 keeps OFF, the power switch S4 keeps ON, the power switch S1 and the power switch S2 switch between ON and OFF. The direction of the current is shown as FIG. 2(c) and FIG. 2(d). In FIG. 2(c), the current flows successively through the power switch S4, the power switch S1 and the inductor L1. In FIG. 2(d), the current flows successively through the power switch S4, the output capacitor Cout, the power switch S2 and the inductor L1.

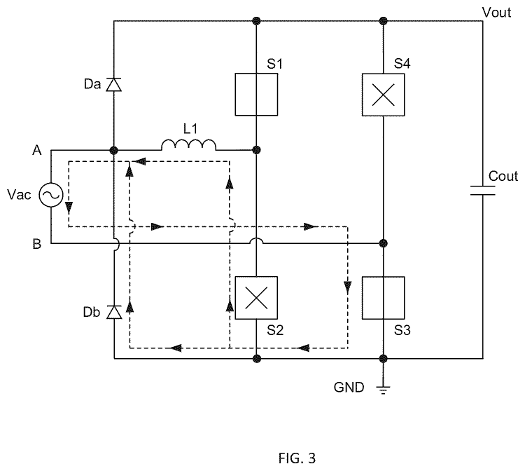

The inventors recognized that when condition such as lightning strike, voltage surge or other high-voltage spike occurs, the AC input voltage Vac may reverse suddenly and a reverse current may be generated, thereby ruining the totem pole PFC circuit 100. Take the positive half cycle of the AC input voltage Vac as an example, as shown in FIG. 3, the power switch S3 keeps ON when the AC input voltage Vac is in the positive half cycle. If the AC input voltage Vac changes from positive to negative suddenly, a reverse current will be generated and flow from a node B into a node A through the power switch S3 and the diode Db. The reverse current may also flow from the node B into the node A through the power switch S3, a body diode of the power switch S2 and the inductor L1. As a result, the diode Db and the power switches S2 and S3 may be ruined. Similarly, when the AC input voltage Vac is in the negative half cycle, if the AC input voltage Vac changes from negative to positive suddenly, the reverse current may ruin the diode Da and the power switches S1 and S4.

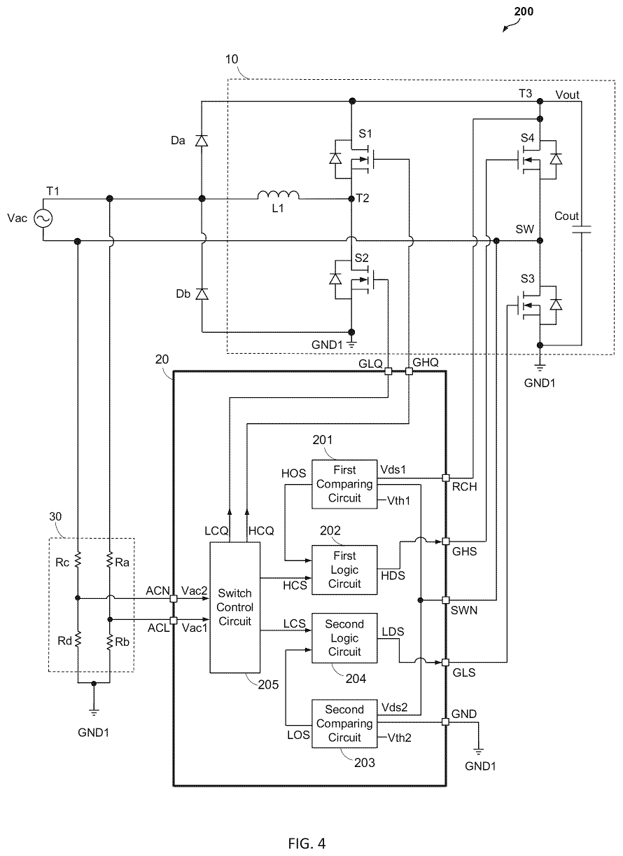

FIG. 4 illustrates a block diagram of a totem pole PFC circuit 200 in accordance with an embodiment of the present invention. As shown in FIG. 4, the totem pole PFC circuit 200 includes a switching circuit 10 and a control circuit 20. The switching circuit 10 includes an inductor L1, power switches S1˜S4 and an output capacitor Cout. The inductor L1 is coupled between a first node T1 and a second node T2. The power switch S1 is coupled between an output node T3 and the second node T2. The power switch S2 is coupled between the second node T2 and a reference ground GND1. The low side power switch S3 is coupled between a switching node SW and the reference ground GND1. The high side power switch S4 is coupled between the output node T3 and the switching node SW. The output capacitor Cout is coupled between the output node T3 and the reference ground GND1. The switching circuit 10 is configured to convert an AC input voltage Vac into an output voltage Vout via the turning-on and the turning-off of the power switches S1˜S4. The totem pole PFC circuit 200 further includes a diode Da coupled between the output node T3 and the first node T1 and a diode Db coupled between the first node T1 and the reference ground GND1 to speed up the start-up of the totem pole PFC circuit 200. Those skilled in the art can understand that the power switches S1˜S4 may be any controllable semiconductor device, such as BJT, JFET, MOSFET, IGBT, GaNFET and so on.

The control circuit 20 includes a plurality of pins, including a pin GHQ, a pin GLQ a pin RCH, a pin GHS, a pin SWN, a pin GLS, a pin GND, a pin ACL and a pin ACN. The pin GHQ is coupled to a control terminal of the power switch S1. The pin GLQ is coupled to a control terminal of the power switch S2. The pin RCH is coupled to the output node T3. The pin GHS is coupled to a control terminal of the high side power switch S4. The pin SWN is coupled to the switching node SW. The pin GLS is coupled to a control terminal of the low side power switch S3. The pin GND is coupled to the reference ground GND1. The pins ACL and ACN are coupled to the AC input voltage Vac.

In the example shown in FIG. 4, the totem pole PFC circuit 200 further includes an input voltage sensing circuit 30. The input voltage sensing circuit 30 includes resistors Ra˜Rd, where a common connection node of the resistors Ra and Rb provides a first voltage signal Vac1 and a common connection node of the resistors Rc and Rd provides a second voltage signal Vac2. The control circuit 20 is configured to receive the first voltage signal Vca1 and the second voltage signal Vca2 through the pin ACL and the pin ACN respectively and to sense the AC input voltage Vac based on the first voltage signal Vac1 and the second voltage signal Vac2. In one embodiment, Vac=(Vac1−Vac2)/k, where k is a proportional coefficient.

In the example shown in FIG. 4, the control circuit 20 further includes a first comparing circuit 201, a first logic circuit 202, a second comparing circuit 203, a second logic circuit 204 and a switch control circuit 205.

The first comparing circuit 201 is coupled to the pin RCH and the pin SWN to receive a first voltage Vds1 indicative of the drain-source voltage of the high side power switch S4 and configured to compare the first voltage Vds1 with a first threshold voltage Vth1 to generate a high side off signal HOS. In one embodiment, when the first voltage Vds1 is higher than the first threshold voltage Vth1, the high side off signal HOS is valid (e.g., logic High). In one embodiment, the first comparing circuit 201 has a first input terminal, a second input terminal, a reference ground terminal and an output terminal, where the first input terminal is coupled to the pin RCH, the second input terminal receives the first threshold voltage Vth1, the reference ground terminal is coupled to the pin SWN and the output terminal provides the high side off signal HOS.

The switch control circuit 205 is coupled to the pins ACL and ACN to sense the AC input voltage Vac and configured to generate a high side control signal HCS and a low side control signal LCS based on the AC input voltage Vac. In one embodiment, when the AC input voltage Vac is in a positive half cycle, the high side control signal HCS is invalid (e.g., logic low) and the low side control signal LCS is valid (e.g., logic high); when the AC input voltage Vac is in a negative half cycle, the high side control signal HCS is valid (e.g., logic high) and the low side control signal LCS is invalid (e.g., logic low). In one embodiment, the AC input voltage Vac is in the positive half cycle when the AC input voltage Vac is higher than a positive threshold voltage Vzero and the AC input voltage Vac is in the negative half cycle when the AC input voltage Vac is lower than a negative threshold voltage −Vzero. In one embodiment, the positive threshold voltage Vzero may approach zero but be higher than zero and the negative threshold voltage −Vzero may approach zero but be lower than zero. In the example shown in FIG. 4, the switch control circuit 205 is further configured to generate switch control signals HCQ and LCQ to control the power switches S1 and S2 respectively.

The first logic circuit 202 is configured to receive the high side off signal HOS and the high side control signal HCS and to generate a high side drive signal HDS to control the high side power switch S4. In one embodiment, when the high side off signal HOS is valid or the high side control signal HCS is invalid, the high side power switch S4 is turned off.

The second comparing circuit 203 is coupled to the pin SWN and the pin GND to receive a second voltage Vds2 indicative of the drain-source voltage of the low side power switch S3 and configured to compare the second voltage Vds2 with a second threshold voltage Vth2 to generate a low side off signal LOS. In one embodiment, when the second voltage Vds2 is higher than the second threshold voltage Vth2, the low side off signal LOS is valid (e.g., logic High). In one embodiment, the first threshold voltage Vth1 and the second threshold voltage Vth2 have same value. In one embodiment, the second comparing circuit 203 has a first input terminal, a second input terminal, a reference ground terminal and an output terminal, where the first input terminal is coupled to the pin SWN, the second input terminal receives the second threshold voltage Vth2, the reference ground terminal is coupled to the pin GND and the output terminal provides the low side off signal LOS.

The second logic circuit 204 is configured to receive the low side off signal LOS and the low side control signal LCS and to generate a low side drive signal LDS to control the low side power switch S3. In one embodiment, when the low side off signal LOS is valid or the low side control signal LCS is invalid, the low side power switch S3 is turned off.

In one embodiment, the control circuit 20 further includes a driving circuit (not shown) for driving the power switches S1˜S4.

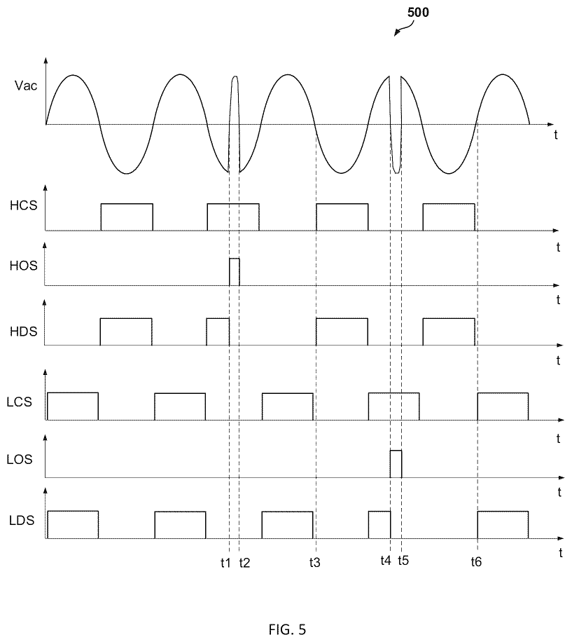

FIG. 5 illustrates working waveforms of the totem pole PFC circuit 200 shown in FIG. 4 in accordance with an embodiment of the present invention. Next, the working principle of the totem pole PFC circuit 200 will be set forth with reference to FIG. 4 and FIG. 5.

When the AC input voltage Vac is in the negative half cycle, the high side control signal HCS is logic high. During time t1˜t2, the AC input voltage Vac changes from negative to positive and a reverse current flowing through the drain terminal to the source terminal of the high side power switch S4 is generated. The first voltage Vds1 becomes higher than the first threshold voltage Vth1 and thus the high side off signal HOS switches to logic high. In response to the logic high of the high side off signal HOS, the high side drive signal HDS switches from logic high to logic low to turn off the high side power switch S4. Then the high side power switch S4 keeps off until time t3. At time t3, the next negative half cycle of the AC input voltage Vac comes, i.e., a rising edge of the high side control signal HCS comes, the high side drive signal HDS switches from logic low to logic high to turn on the high side power switch S4.

Similarly, when the AC input voltage Vac is in the positive half cycle, the low side control signal LCS is logic high. During time t4˜t5, the AC input voltage Vac changes from positive to negative and a reverse current flowing through the drain terminal to the source terminal of the low side power switch S3 is generated. The second voltage Vds2 becomes higherthan the second threshold voltage Vth2 and thus the low side off signal LOS switches to logic high. In response to the logic high of the low side off signal LOS, the low side drive signal LDS switches from logic high to logic low to turn off the low side power switch S3. Then the low side power switch S3 keeps off until time t6. At time t6, the next positive half cycle of the AC input voltage Vac comes, i.e., a rising edge of the low side control signal LCS comes, the low side drive signal LDS switches from logic low to logic high to turn on the low side power switch S3.

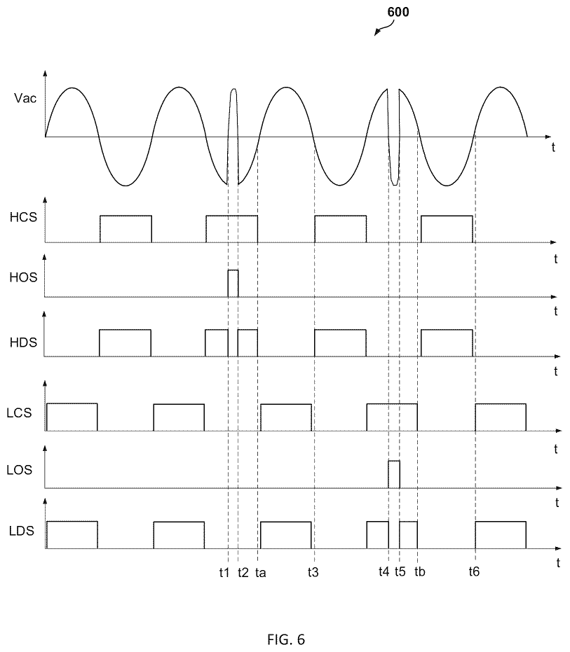

FIG. 6 illustrates working waveforms of the totem pole PFC circuit 200 shown in FIG. 4 in accordance with another embodiment of the preset invention. Different from FIG. 5, in the example shown in FIG. 6, when the AC input voltage Vac recovers to negative at time t2, the high side drive signal HDS switches from logic low to logic high to turn on the high side power switch S4. Similarly, when the AC input voltage Vac recovers to positive at time t5, the low side drive signal LDS switches from logic low to logic high to turn on the low side power switch S3.

Those skilled in the art can understand that the power switches S3 and S4 can be turned on at any suitable time after the AC input voltage Vac recovers to normal. For example, the high side power switch S4 may be turned on at any time during time t2˜ta of FIG. 6 and the low side power switch S3 may be turned on at any time during time t5˜tb of FIG. 6.

According to the embodiments of the present invention, when the first voltage Vds1 becomes higherthan the first threshold voltage Vth1, the high side power switch S4 is turned off to cut off the current loop of the reverse current flowing through the high side power switch S4. When the second voltage Vds2 becomes higher than the second threshold voltage Vth2, the low side power switch S3 is turned off to cut off the current loop of the reverse current flowing through the low side power switch S3. This can limit the reverse current quickly and effectively and thus protect the power switches and diodes of the switching converter 200 from damage by the reverse current. Besides, the reverse current can be sensed without additional device such as current sensing resistor, this can reduce the power loss and increase the circuit efficiency.

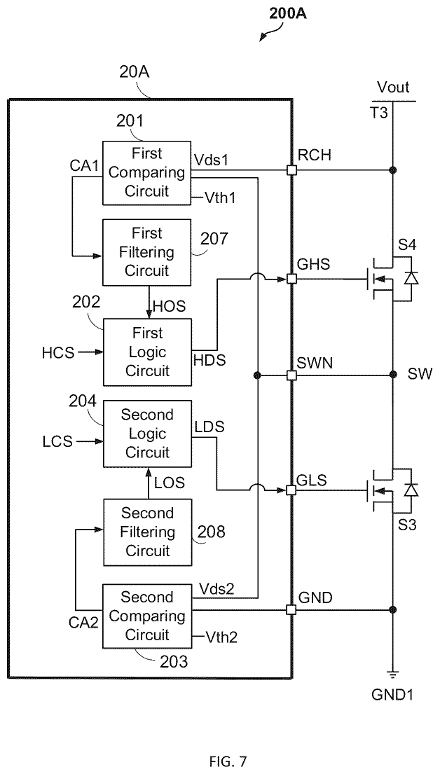

FIG. 7 illustrates a block diagram of a totem pole PFC circuit 200A in accordance with another embodiment of the present invention. Different from FIG. 4, the control circuit 20A shown in FIG. 0.7 further includes a first filtering circuit 207 and a second filtering circuit 208. In the example shown in FIG. 7, the first comparing circuit 201 generates the first comparing signal CA1 based on the comparison result between the first voltage Vds1 and the first threshold voltage Vth1. The first filtering circuit 207 is coupled to the first comparing circuit 201 to receive the first comparing signal CA1 and provides the high side off signal HOS by filtering out the noise of the first comparing signal CA1.

Similarly, the second comparing circuit 203 generates the second comparing signal CA2 based on the comparison result between the second voltage Vds2 and the second threshold voltage Vth2. The second filtering circuit 208 is coupled to the second comparing circuit 203 to receive the second comparing signal CA2 and provides the low side off signal LOS by filtering out the noise of the second comparing signal CA2.

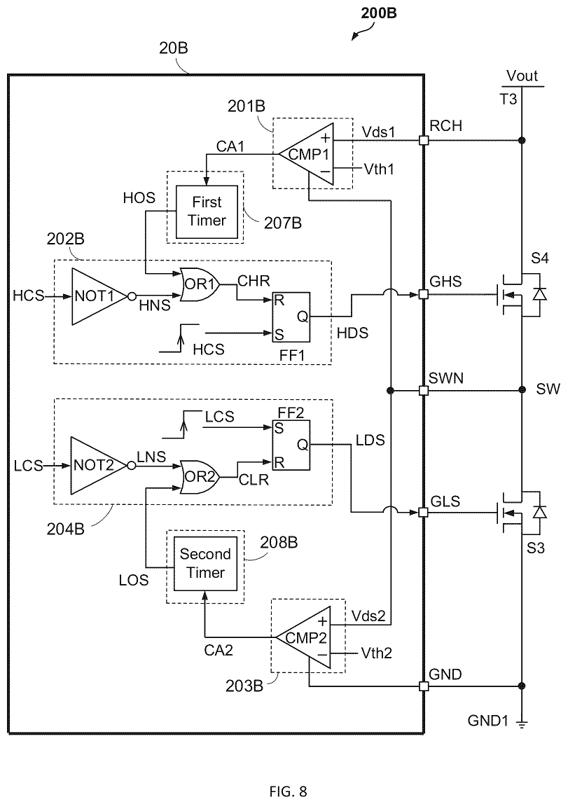

FIG. 8 illustrates a circuit schematic of a totem pole PFC circuit 200B in accordance with an embodiment of the present invention. As shown in FIG. 8, the first comparing circuit 201B includes a comparator CMP1. The comparator CMP1 has a non-inverting input terminal, an inverting input terminal, a reference ground terminal and an output terminal, where the non-inverting input terminal is coupled to the pin RCH, the inverting input terminal is coupled to receive the first threshold voltage Vth1 and the reference ground terminal is coupled to the pin SWN. The comparator CMP1 compares the first voltage Vds1 with the first threshold voltage Vth1 and generates the first comparing signal CA1 at the output terminal. When the first voltage Vds1 is higher than the first threshold voltage Vth1, the first comparing signal CA1 is logic high.

The first filtering circuit 207B includes a first timer. The first timer times the logic high duration of the first comparing signal CA1 and generates the high side off signal HOS. When the timing duration of the first timer becomes longer than a first time threshold tth1, the high side off signal HOS switches from logic low to logic high. Those skilled in the art can understand that the first comparing signal CA1 may jitter and jump between logic high and logic low due to noise, the first timer can accumulate timing the logic high duration of the first comparing signal CA1 within one negative half cycle of the AC input voltage Vac to reduce the impact of the noise.

The first logic circuit 202B includes a NOT gate NOT1, an OR gate OR1 and a flip-flop FF1. The NOT gate NOT1 performs logic NOT operation on the high side control signal HCS and generates a high side not signal HNS. The OR gate OR1 performs logic OR operation on the high side off signal HOS and the high side not signal HNS and generates a high side or signal CHR. The flip-flop FF1 has a set terminal S, a reset terminal R and an output terminal Q, where the set terminal S receives the high side control signal HCS, the reset terminal R receives the high side or signal CHR and the output terminal provides the high side drive signal HDS. When a rising edge of the high side control signal HCS comes, the high side drive signal HDS is logic high; when the high side or signal CHR is logic high, the high side drive signal HDS is logic low.

The second comparing circuit 203B includes a comparator CMP2. The comparator CMP2 has a non-inverting input terminal, an inverting input terminal, a reference ground terminal and an output terminal, where the non-inverting input terminal is coupled to the pin SWN, the inverting input terminal is coupled to receive the second threshold voltage Vth2 and the reference ground terminal is coupled to the pin GND. The comparator CMP2 compares the second voltage Vds2 with the second threshold voltage Vth2 and generates the second comparing signal CA2 at the output terminal. When the second voltage Vds2 is higher than the second threshold voltage Vth2, the second comparing signal CA2 is logic high.

The second filtering circuit 208B includes a second timer. The second timer times the logic high duration of the second comparing signal CA2 and generates the low side off signal LOS. When the timing duration of the second timer becomes longer than a second time threshold tth2, the low side off signal LOS switches from logic low to logic high. Those skilled in the art can understand that the second comparing signal CA2 may jitter and jump between logic high and logic low due to noise, the second timer can accumulate timing the logic high duration of the second comparing signal CA2 within one positive half cycle of the AC input voltage Vac. In one embodiment, the first time threshold tth1 and the second time threshold tth2 have same value, such as 200 nS.

The second logic circuit 204B includes a NOT gate NOT2, an OR gate OR2 and a flip-flop FF2. The NOT gate NOT2 performs logic NOT operation on the low side control signal LCS and generates a low side not signal LNS. The OR gate OR2 performs logic OR operation on the low side off signal LOS and the low side not signal LNS and generates a low side or signal CLR. The flip-flop FF2 has a set terminal S, a reset terminal R and an output terminal Q, where the set terminal S receives the low side control signal LCS, the reset terminal R receives the low side or signal CLR and the output terminal provides the low side drive signal LDS. When a rising edge of the low side control signal LCS comes, the low side drive signal LDS is logic high; when the low side or signal CLR is logic high, the low side drive signal LDS is logic low.

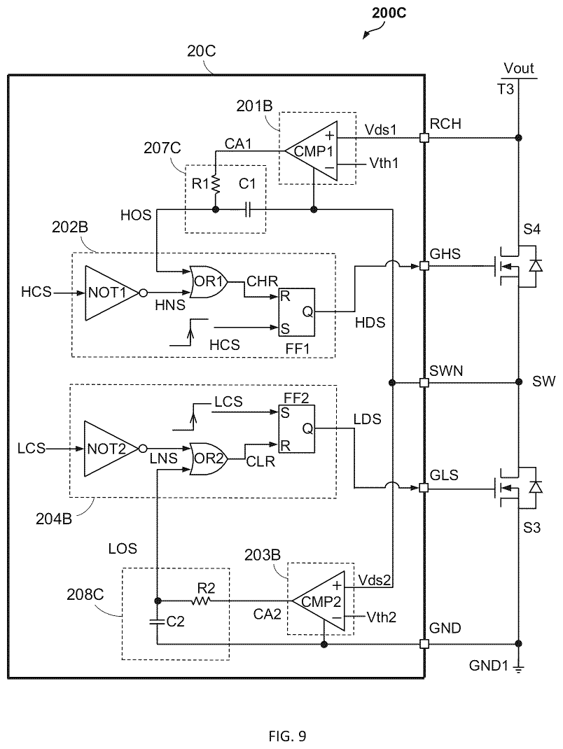

FIG. 9 illustrates a circuit schematic of a totem pole PFC circuit 200C in accordance with another embodiment of the present invention. Different from FIG. 8, the first filtering circuit 207C in FIG. 9 includes a resistor R1 and a capacitor C1. The resistor R1 and the capacitor C1 forms a low pass filter for filtering out the noise spikes of the first comparing signal CA1.

The second filtering circuit 208C in FIG. 0.9 includes a resistor R2 and a capacitor C2. The resistor R2 and the capacitor C2 forms a low pass filter for filtering out the noise spikes of the second comparing signal CA2.

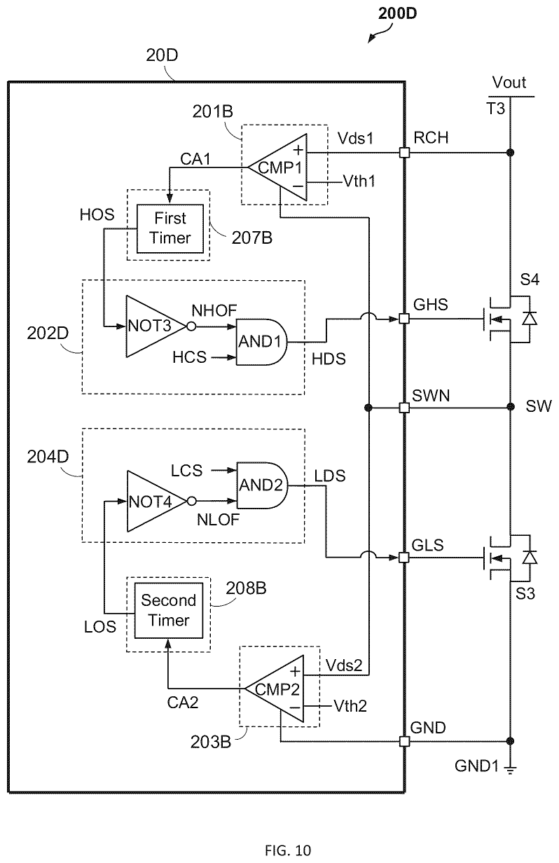

FIG. 10 illustrates a circuit schematic of a totem pole PFC circuit 200D in accordance with an embodiment of the present invention. Different from FIG. 8, the first logic circuit 202D in FIG. 10 includes a NOT gate NOT3 and an AND gate AND1. The NOT gate NOT3 performs logic NOT operation on the high side off signal HOS and generates a high side not off signal NHOF. The AND gate AND1 performs logic AND operation on the high side not off signal NHOF and the high side control signal HCS and generates the high side drive signal HDS.

The second logic circuit 204D in FIG. 10 includes a NOT gate NOT4 and an AND gate AND2. The NOT gate NOT4 performs logic NOT operation on the low side off signal LOS and generates a low side not off signal NLOF. The AND gate AND2 performs logic AND operation on the low side not off signal NLOF and the low side control signal LCS and generates the low side drive signal LDS.

Those skilled in the art can understand that the examples shown in FIGS. 7˜10 are exemplary illustrations, other suitable circuits are also applicable.

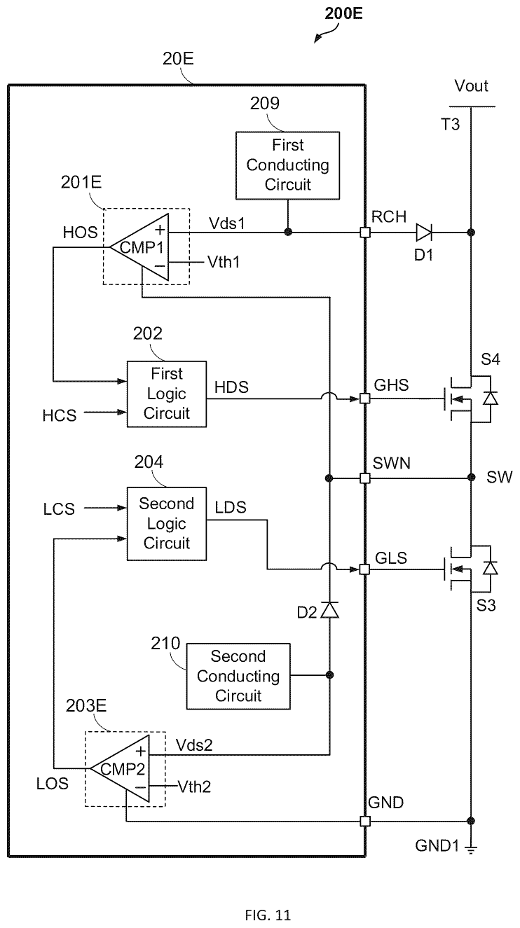

FIG. 11 illustrates a circuit schematic of a totem pole PFC circuit 200E in accordance with an embodiment of the present invention. As shown in FIG. 11, the totem pole PFC circuit 200E further includes a first unidirectional device D1, a first conducting circuit 209, a second unidirectional device D2 and a second conducting circuit 210. In one embodiment, the first unidirectional device D1 and the second unidirectional device D2 include diodes.

In the example shown in FIG. 11, the first unidirectional device D1 is coupled between the pin RCH and the drain terminal of the high side power switch S4 (i.e., the output node T3). In one embodiment, the first unidirectional device D1 has an anode and a cathode, where the anode is coupled to the pin RCH and the cathode is coupled to the drain terminal of the high side power switch S4.

The first conducting circuit 209 is coupled to the pin RCH. When the AC input voltage Vac is in the negative half cycle, the first conducting circuit 209 turns on the first unidirectional device D1 to provide a conduction path between the pin RCH and the drain terminal of the high side power switch S4, thereby the first comparing circuit 201E can receive the first voltage Vds1 indicative of the drain-source voltage of the high side power switch S4. In one embodiment, when the AC input voltage Vac is in the positive half cycle, the first unidirectional device D1 is turned off to cut off the conduction path between the pin RCH and the drain terminal of the high side power switch S4.

In one embodiment, the voltage at the cathode of the first unidirectional device D1 is equal to the output voltage Vout and the voltage at the anode of the first unidirectional device D1 is related to the voltage at the pin SWN. When the AC input voltage Vac is in the negative half cycle, the high side power switch S4 is turned on and the voltage at the pin SWN is equal to the output voltage Vout. The voltage across the first unidirectional device D1 is higher than a conduction threshold of the first unidirectional device D1, thus the first unidirectional device D1 is turned on. When the AC input voltage Vac is in the positive half cycle, the low side power switch S3 is turned on and the voltage at the pin SWN is equal to the reference ground GND1. The voltage across the first unidirectional device D1 is lower than the conduction threshold of the first unidirectional device D1, thus the first unidirectional device D1 keeps off.

The second unidirectional device D2 is coupled between the first input terminal of the second comparing circuit 203E and the pin SWN. In one embodiment, the second unidirectional device D2 has an anode and a cathode, where the anode is coupled to the first input terminal of the second comparing circuit 203E and the cathode is coupled to the pin SWN.

The second conducting circuit 210 is coupled to the second unidirectional device D2. When the AC input voltage Vac is in the positive half cycle, the second conducting circuit 210 turns on the second unidirectional device D2 to provide a conduction path between the first input terminal of the second comparing circuit 203E and the pin SWN, thereby the second comparing circuit 203E can receive the second voltage Vds2 indicative of the drain-source voltage of the low side power switch S3. In one embodiment, when the AC input voltage Vac is in the negative half cycle, the second unidirectional device D2 is turned off to cut off the conduction path between the first input terminal of the second comparing circuit 203E and the pin SWN.

In one embodiment, the voltage at the cathode of the second unidirectional device D2 is equal to the voltage at the pin SWN. When the AC input voltage Vac is in the positive half cycle, the low side power switch S3 is turned on and the voltage at the pin SWN is equal to the reference ground GND1. The voltage across the second unidirectional device D2 is higher than a conduction threshold of the second unidirectional device D2, thus the second unidirectional device D2 is turned on. When the AC input voltage Vac is in the negative half cycle, the high side power switch S4 is turned on and the voltage at the pin SWN is equal to the output voltage Vout. The voltage across the second unidirectional device D2 is lower than the conduction threshold of the second unidirectional device D2, thus the second unidirectional device D2 keeps off.

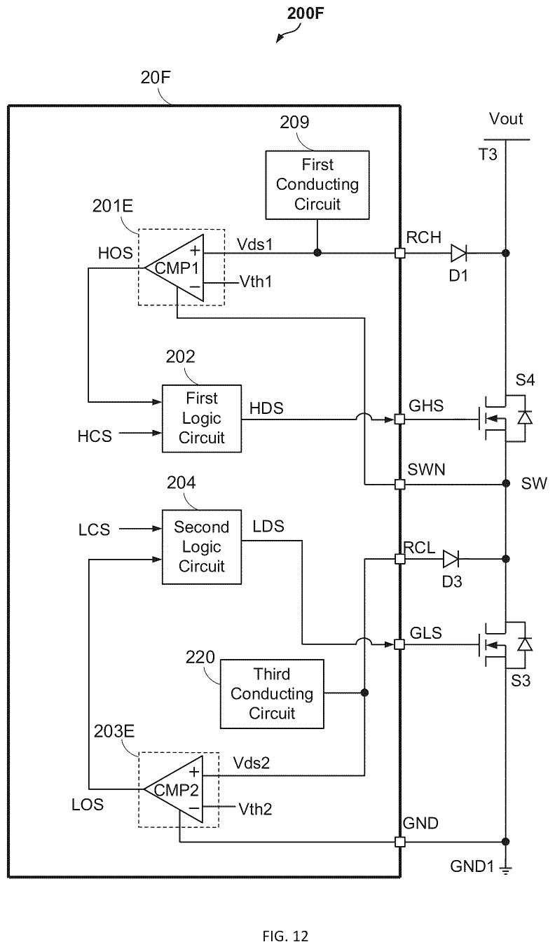

In other embodiments, the second unidirectional device can also be external to the control circuit 20E. As shown in FIG. 12, the control circuit 20F further includes a pin RCL coupled to the switching node SW through a third unidirectional device D3. In the example shown in FIG. 12, the third unidirectional device D3 includes a diode. The third unidirectional device D3 has an anode and a cathode, where the anode is coupled to the pin RCL and the cathode is coupled to the switching node SW. When the AC input voltage Vac is in the positive half cycle, the third conducting circuit 220 turns on the third unidirectional device D3 to provide a conduction path between the pin RCL and the switching node SW. When the AC input voltage Vac is in the negative half cycle, the third unidirectional device D3 is turned off to cut off the conduction path between the pin RCL and the switching node SW.

In one embodiment, the voltage at the cathode of the third unidirectional device D3 is equal to the voltage at switching node SW. When the AC input voltage Vac is in the positive half cycle, the low side power switch S3 is turned on and the voltage at switching node SW is equal to the reference ground GND1. The voltage across the third unidirectional device D3 is higher than a conduction threshold of the third unidirectional device D3, thus the third unidirectional device D3 is turned on. When the AC input voltage Vac is in the negative half cycle, the high side power switch S4 is turned on and the voltage at switching node SW is equal to the output voltage Vout. The voltage across the third unidirectional device D3 is lower than the conduction threshold of the third unidirectional device D3, thus the third unidirectional device D3 keeps off.

In one embodiment, the unidirectional devices D1˜D3 are high-voltage devices for limiting the voltage of the pin RCH and/or the pin RCL, thereby protecting the internal circuits and devices of the control circuit 20 from damage by the high voltage.

In one embodiment, the first conducting circuit 209 is disabled when the AC input voltage Vac is in the positive half cycle and the second conducting circuit 210/the third conducting circuit 220 is disabled when the AC input voltage Vac is in the negative half cycle to further reduce the power loss.

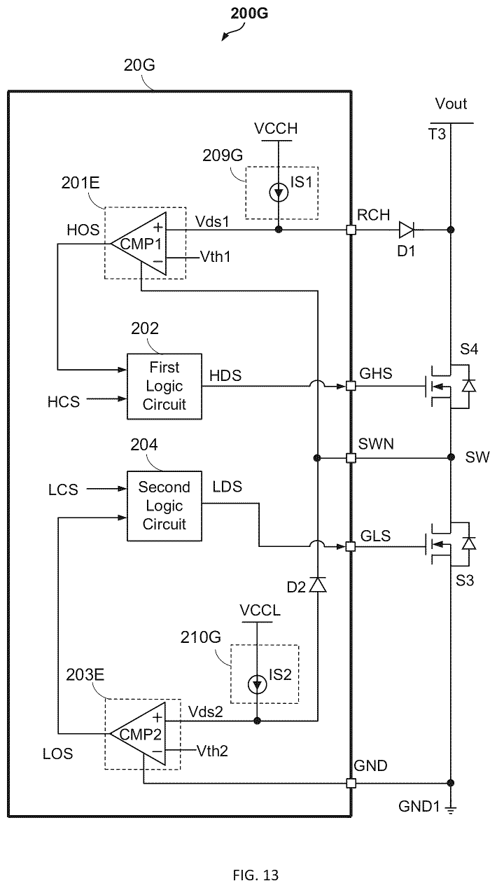

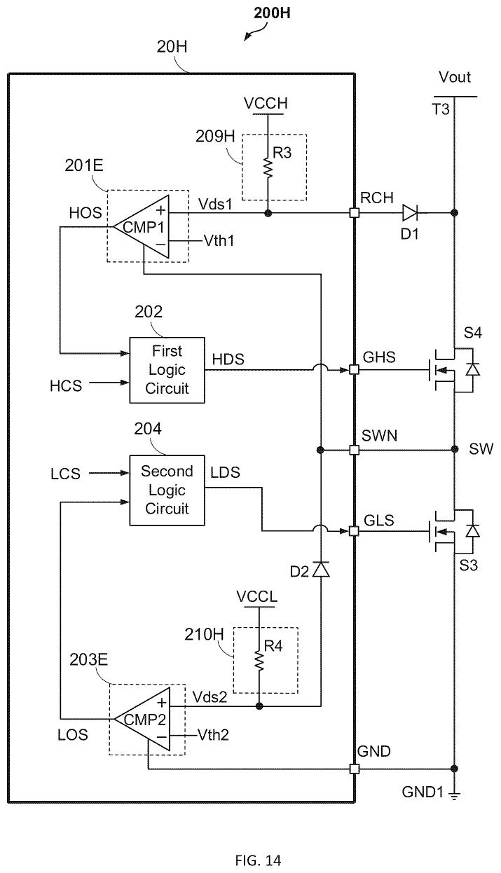

The first conducting circuit 209, the second conducting circuit 210 and the third conducting circuit 220 have many suitable circuit configurations. In the example shown in FIG. 13, the first conducting circuit 209G includes a current source IS1 coupled between a first supply voltage VCCH and the pin RCH. The second conducting circuit 210G includes a current source IS2 coupled between a second supply voltage VCCL and the first input terminal of the second comparing circuit 203E. In one embodiment, the current source IS1 is turned on when the AC input voltage Vac is in the negative half cycle and the current source IS2 is turned on when the AC input voltage Vac is in the positive half cycle. In the example shown in FIG. 14, the first conducting circuit 209H includes a resistor R3 coupled between the first supply voltage VCCH and the pin RCH. The second conducting circuit 210H includes a resistor R4 coupled between the second supply voltage VCCL and the first input terminal of the second comparing circuit 203E.

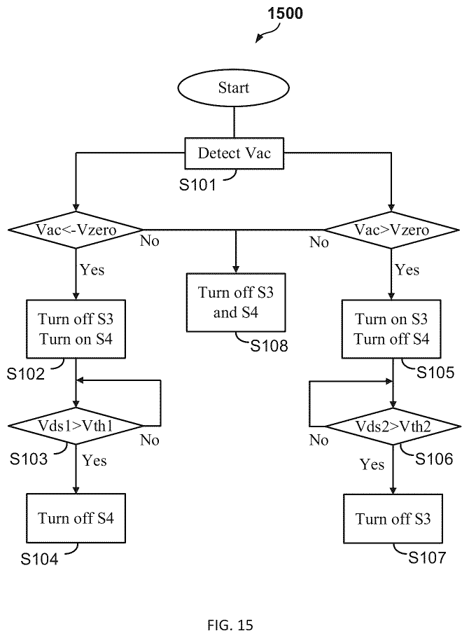

FIG. 15 illustrates a flowchart of a control method 1500 used in a totem pole PFC circuit in accordance with an embodiment of the present invention. The totem pole PFC circuit includes power switches S1˜S4 connected as FIG. 4 and converts an AC input voltage Vac into an output voltage Vout via the turning-on and turning-off of the power switches S1˜S4. The control method 1500 includes steps S101˜S108.

At step S101, whether the AC input voltage Vac is in a positive half cycle or in a negative half cycle is determined. If the AC input voltage Vac is in the negative half cycle, go to step S102; if the AC input voltage Vac is in the positive half cycle, go to step S105; if the AC input voltage Vac is neither in the positive half cycle nor in the negative half cycle, go to step S108. In one embodiment, the AC input voltage Vac is in the positive half cycle when the AC input voltage Vac is higher than a positive threshold voltage Vzero and the AC input voltage Vac is in the negative half cycle when the AC input voltage Vac is lower than a negative threshold voltage −Vzero. In one embodiment, the positive threshold voltage Vzero may approach zero but be higher than zero and the negative threshold voltage −Vzero may approach zero but be lower than zero.

At step S102, the low side power switch S3 is turned off and the high side power switch S4 is turned on.

At step S103, a first voltage Vds1 indicative of the drain-source voltage of the high side power switch S4 is monitored and the first voltage Vds1 is compared with a first threshold voltage Vth1. If the first voltage Vds1 is higher than the first threshold voltage Vth1, go to step S104; otherwise, repeat step S103.

At step S104, the high side power switch S4 is turned off.

At step S105, the low side power switch S3 is turned on and the high side power switch S4 is turned off.

At step S106, a second voltage Vds2 indicative of the drain-source voltage of the low side power switch S3 is monitored and the second voltage Vds2 is compared with a second threshold voltage Vth2. If the second voltage Vds2 is higher than the second threshold voltage Vth2, go to step S107; otherwise, repeat step S106.

At step S107, the low side power switch S3 is turned off.

At step S108, the power switches S3 and S4 are both turned off.

Those skilled in the art can understand that, in the flowchart described above, the steps may also be performed in an order different from the order shown as FIG. 15. For example, two successive steps may be performed meanwhile, or may be performed in a reverse order sometimes, it depends to the specific function involved.

Those skilled in the art can understand that the logic high/logic low of control signal is related to the type of the power switch. For example, if the power switch is N-type MOSFET, when the control signal is logic high, the power switch is turned on; when the control signal is logic low, the power switch is turned off. If the power switch is P-type MOSFET, when the control signal is logic high, the power switch is turned off; when the control signal is logic low, the power switch is turned on. The logic high/logic low of the control signals shown in the above embodiments are used for illustrative purposes, not used for limiting the present invention. Those skilled in the art can understand that the circuits shown in the above embodiments are exemplary illustrations, other suitable circuits can also be applicable. In other embodiments, the working principle of the control circuit can be described by digital language such as VHDL, Verilog, thereby generating digital circuits to realize the functions of the control circuit.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A control circuit for a totem pole PFC (power factor correction) circuit with a high side power switch coupled between an output node and a switching node and a low side power switch coupled between the switching node and a reference ground, the control circuit comprising:
a first pin configured to be coupled to the output node;
a second pin configured to be coupled to a control terminal of the high side power switch;
a third pin configured to be coupled to the switching node;
a fourth pin;
a fifth pin, wherein the fourth pin and the fifth pin are configured to be coupled to an AC (alternating current) input voltage;
a switch control circuit configured to generate a high side control signal based on the AC input voltage;
a first comparing circuit coupled to the first pin and the third pin and configured to generate a high side off signal by comparing a first voltage indicative of a drain-source voltage of the high side power switch with a first threshold voltage; and
a first logic circuit configured to generate a high side drive signal to control the high side power switch based on the high side control signal and the high side off signal.

2. The control circuit of claim 1, wherein when the first voltage is higher than the first threshold voltage, the high side power switch is turned off.

3. The control circuit of claim 1, wherein the first pin is further configured to be coupled to the output node through a first unidirectional device, the control circuit further comprising:
a first conducting circuit coupled to the first pin and configured to provide a conduction path between the first pin and the output node when the AC input voltage is in a negative half cycle.

4. The control circuit of claim 3, wherein the first conducting circuit comprises a current source or a resistor coupled between a first supply voltage and the first pin.

5. The control circuit of claim 1, wherein the switch control circuit is further configured to generate a low side control signal based on the AC input voltage, the control circuit further comprising:
a sixth pin configured to be coupled to a control terminal of the low side power switch;
a seventh pin configured to be coupled to the reference ground;
a second comparing circuit coupled to the third pin and the seventh pin and configured to generate a low side off signal by comparing a second voltage indicative of a drain-source voltage of the low side power switch with a second threshold voltage; and
a second logic circuit configured to generate a low side drive signal to control the low side power switch based on the low side control signal and the low side off signal.

6. The control circuit of claim 5, further comprising:
a second unidirectional device coupled between an input terminal of the second comparing circuit and the third pin; and
a second conducting circuit coupled to the second unidirectional device and configured to provide a conduction path between the input terminal of the second comparing circuit and the third pin when the AC input voltage is in a positive half cycle.

7. The control circuit of claim 5, further comprising:
an eighth pin configured to be coupled to the switching node through a third unidirectional device, wherein the second comparing circuit is coupled to the eighth pin and the seventh pin; and
a third conducting circuit coupled to the eighth pin and configured to provide a conduction path between the eighth pin and the switching node when the AC input voltage is in a positive half cycle.

8. The control circuit of claim 1, further comprising:
a first filtering circuit coupled to the first comparing circuit and configured to filter out the noise of the comparison result.

9. A control circuit for a totem pole PFC circuit with a high side power switch coupled between an output node and a switching node and a low side power switch coupled between the switching node and a reference ground, the control circuit comprising:
a first pin configured to be coupled to the switching node;
a second pin configured to be coupled to the switching node through a first unidirectional device;
a third pin configured to be coupled to a control terminal of the low side power switch; and
a fourth pin configured to be coupled to the reference ground; wherein
the control circuit is configured to control the turning-off of the low side power switch based on a first voltage indicative of a drain-source voltage of the low side power switch.

10. The control circuit of claim 9, further comprising:
a fifth pin configured to be coupled to the output node through a second unidirectional device; and
a six pin configured to be coupled to a control terminal of the high side power switch; wherein
the control circuit is configured to control the turning-off of the high side power switch based on a second voltage indicative of a drain-source voltage of the high side power switch.

11. The control circuit of claim 9, further comprising:
a seventh pin; and
an eighth pin, wherein the seventh pin and the eighth pin are configured to be coupled to an AC input voltage; wherein
the control circuit is further configured to control the low side power switch based on the AC input voltage.

12. The control circuit of claim 11, further comprising:
a first conducting circuit coupled to the second pin and configured to provide a conduction path between the second pin and the switching node when the AC input voltage is in a positive half cycle; and
a first comparing circuit coupled to the second pin and the fourth pin and configured to generate a low side off signal to control the turning-off of the low side power switch by comparing the first voltage with a first threshold voltage.

13. A totem pole PFC circuit comprising:
an inductor coupled between a first node and a second node;
a first power switch coupled between an output node and the second node;
a second power switch coupled between the second node and a reference ground;
a high side power switch coupled between the output node and a switching node;
a low side power switch coupled between the switching node and the reference ground;
a switch control circuit configured to generate a high side control signal based on an AC input voltage;
a first comparing circuit coupled to the output node and the switching node and configured to generate a high side off signal by comparing a first voltage indicative of a drain-source voltage of the high side power switch with a first threshold voltage; and
a first logic circuit configured to generate a high side drive signal to control the high side power switch based on the high side control signal and the high side off signal.

14. The totem pole PFC circuit of claim 13, wherein when the first voltage is higher than the first threshold voltage, the high side power switch is turned off.

15. The totem pole PFC circuit of claim 13, further comprising:
a first diode coupled between the output node and the first node; and
a second diode coupled between the first node and the reference ground.

16. The totem pole PFC circuit of claim 13, further comprising:
a first unidirectional device coupled between an input terminal of the first comparing circuit and the output node; and
a first conducting circuit coupled to the first unidirectional device and configured to provide a conduction path between the input terminal of the first comparing circuit and the output node when the AC input voltage is in a negative half cycle.

17. The totem pole PFC circuit of claim 13, wherein the switch control circuit is further configured to generate a low side control signal based on the AC input voltage, the totem pole PFC circuit further comprising:
a second comparing circuit coupled to the switching node and the reference ground and configured to generate a low side off signal by comparing a second voltage indicative of a drain-source voltage of the low side power switch with a second threshold voltage; and
a second logic circuit configured to generate a low side drive signal to control the low side power switch based on the low side control signal and the low side off signal.

18. The totem pole PFC circuit of claim 17, further comprising:
a second unidirectional device coupled between an input terminal of the second comparing circuit and the switching node; and
a second conducting circuit coupled to the second unidirectional device and configured to provide a conduction path between the input terminal of the second comparing circuit and the switching node when the AC input voltage is in a positive half cycle.

19. A control method for a totem pole PFC circuit with a high side power switch coupled between an output node and a switching node and a low side power switch coupled between the switching node and a reference ground, the control method comprising:
generating a high side control signal based on an AC input voltage;
providing a first conduction path through a first unidirectional device when the AC input voltage is in a negative half cycle;
receiving a first voltage indicative of a drain-source voltage of the high side power switch through the first conduction path;
generating a high side off signal by comparing the first voltage with a first threshold voltage; and
generating a high side drive signal to control the high side power switch based on the high side control signal and the high side off signal.

20. The control method of claim 19, further comprising:
generating a low side control signal based on the AC input voltage;
generating a low side off signal by comparing a second voltage indicative of a drain-source voltage of the low side power switch with a second threshold voltage when the AC input voltage is in a positive half cycle; and
generating a low side drive signal to control the low side power switch based on the low side control signal and the low side off signal.
